(19) United States
(12) Patent Application Publication
(10) Pub. No.: US 2006/0105219 A1
(43) Pub. Date: May 18, 2006

(54) Fuel cell component storage or shipment

(76) Inventor: Robert D. Anderson, Stillwater, MN (US)

Correspondence Address: 3M INNOVATIVE PROPERTIES COMPANY, PO BOX 33427, ST. PAUL, MN, 55133-3427, US

(21) Appl. No.: 10/988,740

(22) Filed: Nov. 15, 2004

(51) Int. Cl. H01M 8/02; H01M 2/08

(52) U.S. Cl. 429/34; 429/35; 429/32

(57) ABSTRACT

An article is provided comprising: a) a fuel cell stack comprising at least one port, and b) a humidifying element in communication with the port. The humidifying element may be comprised in a humidifying device, which may form a seal with the port. In another aspect, an article is provided comprising a container, a humidifying element contained within the container, and a fuel cell membrane electrode assembly (MEA) contained within the container. In another aspect, an article is provided comprising a container, a humidifying element contained within the container, and a fuel cell unit cell assembly (UCA) contained within the container. The humidifying element may or may not be contained in a subpocket of the container, which may or may not be impervious to water or substantially impervious to water.

### FIELD OF THE INVENTION

This invention relates to the storage or shipment of fuel cell membrane electrode assemblies, unit cell assemblies or fuel cell stacks.

### SUMMARY OF THE INVENTION

Briefly, the present invention provides an article comprising: a) a fuel cell stack comprising at least one port, and b) a humidifying element in communication with the port. The humidifying element may be comprised in a humidifying device, which may form a seal with the port. The fuel cell stack may or may not comprise an anode inlet port, an anode outlet port, a cathode inlet port, a cathode outlet port. The article may or may not include a humidifying element in communication with each of the four ports.

In another aspect, the present invention provides an article comprising a container, a humidifying element contained within the container, and a fuel cell membrane electrode assembly (MEA) contained within the container. The article may contain one, two or more MEA's. The humidifying element may or may not be contained in a subpocket of the container, which may or may not be impervious to water or substantially impervious to water.

In another aspect, the present invention provides an article comprising a container, a humidifying element contained within the container, and a fuel cell unit cell assembly (UCA) contained within the container. The article may contain one, two or more UCA's. The humidifying element may or may not be contained in a subpocket of the container, which may or may not be impervious to water or substantially impervious to water.

### BRIEF DESCRIPTION OF THE DRAWINGS

FIG. 1 is a schematic depiction of packaged fuel cell membrane electrode assemblies according to the present invention.

FIG. 2 is a schematic depiction of a packaged fuel cell stack according to the present invention.

FIG. 3 is a detail of FIG. 2.

### DETAILED DESCRIPTION

The present invention provides articles and methods for storage and shipment of fuel cell membrane electrode assemblies (MEA's), unit cell assemblies (UCA's) or fuel cell stacks by use of humidifying elements.

A membrane electrode assembly (MEA) is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. Each electrode layer includes electrochemical catalysts, typically including platinum metal. In a typical PEM fuel cell, protons are formed at the anode via hydrogen oxidation and transported across the PEM to the cathode to react with oxygen, causing electrical current to flow in an external circuit connecting the electrodes. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL may also be called a fluid transport layer (FTL) or a diffuser/current collector (DCC). The anode and cathode electrode layers may be applied to GDL's in the form of a catalyst ink, and the resulting coated GDL's sandwiched with a PEM to form a five-layer MEA. Alternately, the anode and cathode electrode layers may be applied to opposite sides of the PEM in the form of a catalyst ink, and the resulting 3-layer MEA sandwiched with two GDL's to form a five-layer MEA. The 3-layer MEA may also be called a catalyst-coated membrane (CCM). The five layers of a five-layer MEA are, in order: anode GDL, anode electrode layer, PEM, cathode electrode layer, and cathode GDL. A 7-layer MEA may be made by addition of appropriate gaskets to each side of a 5-layer MEA. MEA's may additionally include other functional layers, which might include hard stops, hydrophilic or hydrophobic coatings, adhesives, and the like.

Any suitable MEA may be used in the practice of the present invention, including 3-, 5- and 7-layer MEA's with or without GDL's, gaskets, hard stops, hydrophilic or hydrophobic coatings, adhesives, and the like.

The MEA may comprise any suitable PEM, including non-fluorinated, highly fluorinated and perfluorinated PEM's with or without support matrices, such as porous PTFE support matrices. The PEM may comprise any suitable polymer electrolyte. Typical polymer electrolytes useful in fuel cells bear anionic functional groups bound to a common backbone, which are typically sulfonic acid groups but may also include carboxylic acid groups, imide groups, amide groups, or other acidic functional groups. Typical polymer electrolytes are copolymers of tetrafluoroethylene and one or more fluorinated, acid-functional comonomers. Typical polymer electrolytes include NAFION® (DuPont Chemicals, Wilmington, Del.) and FLEMION™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent applications Ser. Nos. 10/322,254, 10/322,226 and 10/325,278, which are incorporated herein by reference. The polymer typically has an equivalent weight (EW) of 1200 or less, more typically 1100 or less, more typically 1000 or less, and more typically 900 or less. In addition to fluorinated membranes, membranes useful in the present invention include hydrocarbon polymers, including aromatic polymers. Examples of useful hydrocarbon polymers include sulfonated polyetheretherketone, sulfonated polysulfone, and sulfonated polystyrene.

The polymer can be formed into a PEM by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 130° C. or higher, most typically 150° C. or higher. The PEM typically has a thickness of less than 50 microns, more typically less than 40 microns, more typically less than 30 microns, and most typically about 25 microns.

Any suitable catalyst may be used in the practice of the present invention. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. Typically, the catalyst is applied to the PEM or to the FTL in the form of a catalyst ink. Alternately, the catalyst ink may be applied to a transfer substrate, dried, and thereafter applied to the PEM or to the FTL as a decal. The catalyst ink typically comprises polymer electrolyte material, which may or may not be the same polymer electrolyte material which comprises the PEM. The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion may be in any suitable solvent system. The electrolyte dispersion is typically an aqueous dispersion, which may additionally contain NMP (n-methyl-2-pyrrolidone), alcohols or polyalcohols such a glycerin and ethylene glycol. The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

Alternately, the MEA may comprise nanostructured catalysts on high-aspect ratio supports as described in U.S. Pat. Nos. 6,425,993, 6,042,959, 6,042,959, 6,319,293, 5,879,828, 6,040,077 and 5,879,827 and U.S. Pat. application Ser. No. 10/674,594, incorporated herein by reference.

To make a 3-layer MEA or CCM, catalyst may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Alternately, catalyst may be applied to the GDL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Any suitable GDL may be used in the practice of the present invention. Typically the GDL is comprised of sheet material comprising carbon fibers. Typically the GDL is a carbon fiber construction selected from woven and non-woven carbon fiber constructions. Carbon fiber constructions which may be useful in the practice of the present invention may include: TORAY™ Carbon Paper, SPECTRACARB™ Carbon Paper, AFN™ non-woven carbon cloth, ZOLTEK™ Carbon Cloth, and the like. The GDL may be coated or impregnated with various materials, which may include carbon particle coatings, hydrophilizing treatments, and hydrophobizing treatments such as coating with polytetrafluoroethylene (PTFE).

To make an MEA, GDL's may be applied to either side of a CCM by any suitable means. Alternately, catalyst coated GDL's may be applied to either side of a PEM by any suitable means.

In one embodiment, MEA's may be incorporated into fuel cell stacks. In a stack, the MEA is typically sandwiched between two rigid plates, known as distribution plates, also known as bipolar plates (BPP's) or monopolar plates. Like the GDL, the distribution plate is typically electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, one face of the BPP may distribute fluids to and from an MEA while the other face contains channels for cooling fluids. Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates or with pairs of bipolar plates.

In one embodiment, MEA's may be incorporated into unit cell assemblies (UCA's), such as described in U.S. patent applications Ser. Nos. 10/295,518 and 10/295,292, incorporated herein by reference.

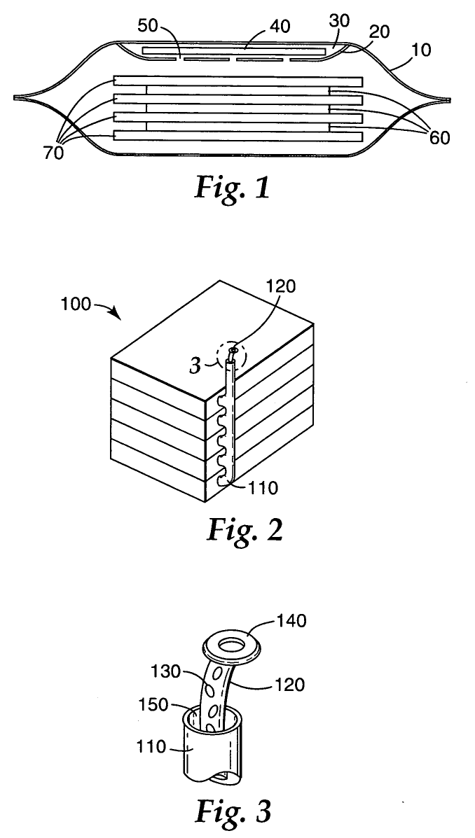

With reference to FIG. 1, one embodiment of the present invention comprises one or several MEA's 70 in a container 10. Container 10 may be made of any suitable material, which may be impervious to water, substantially impervious to water, airtight, substantially airtight, modified atmosphere packaging, watertight, substantially watertight or none of the above. “Impervious to water” means impervious to both liquid water and water vapor. Typically the material is impervious to water or substantially impervious to water. The material of container 10 may be rigid or flexible. The material of container 10 may be single- or multiwall. The interior of container 10 may optionally comprise release materials or coatings. Where two or more MEA's 70 are included in one container 10, they may optionally be interleaved with separators 60. Any suitable material may be used for the separators, which may optionally comprise release materials or coatings. This embodiment further comprises humidifying element 40. Humidifying element 40 may be loose in container 10, or, as depicted in FIG. 1, humidifying element 40 may be contained in subpocket 30 formed by subwall 20. Subwall 20 may include perforations 50 communicating with the interior of the container 10. Humidifying element 40 may be made of any material capable of holding and releasing water, including chemicals such as hydrated salts, hydrophilic materials and physical water containers such as sponges, pads or reservoirs. In an alternate embodiment, UCA are included in container 10 in the place of MEA's 70.

With reference to FIGS. 2 and 3, another embodiment of the present invention comprises a fuel cell stack 100 which comprises at least one port 150 communicating with internal voids in the stack that are adjacent to MEA's. As depicted in FIGS. 2 and 3, port 150 is an opening in manifold 110, which is an external manifold connecting two or more distribution plates. Alternately, port 150 may be an opening in an internal manifold or an opening communicating with a single distribution plate. In this embodiment, port 150 is fitted with humidifying device 120 which contains a humidifying element as described above. Humidifying device 120 may include perforations 130 to allow access to the humidifying element and a plug 140 adapted to seal to port 150. The seal of plug 140 to port 150 may be airtight, substantially airtight, watertight, substantially watertight or neither air- nor watertight. Typically the seal is airtight or substantially airtight. Humidifying device 120 may be made of any suitable material. In one embodiment, the stack is fitted with four humidifying devices at each of the anode gas inlet, the anode gas outlet, the cathode gas inlet and the cathode gas outlet.

In one embodiment of the present invention, the MEA is preconditioned before being sealed or enclosed in a container with a humidifying element, as disclosed in copending U.S. patent application Ser. No. ______ (Atty Docket No. 60339US002) filed on even date herewith, the disclosure of which is incorporated herein by reference. In one embodiment of the present invention, the MEA is preconditioned before being incorporated in a UCA which is sealed or enclosed in a container with a humidifying element. In one embodiment of the present invention, the MEA is preconditioned before being incorporated in a stack which is then fitted with one or more humidifying devices as described above.

This invention is useful in the manufacture and operation of fuel cells.

Various modifications and alterations of this invention will become apparent to those skilled in the art without departing from the scope and principles of this invention, and it should be understood that this invention is not to be unduly limited to the illustrative embodiments set forth hereinabove.

We claim:

1. An article comprising:
a) a fuel cell stack comprising a port, and
b) a humidifying element in communication with the port.

2. The article according to claim 1 wherein said fuel cell stack comprises an anode inlet port, an anode outlet port, a cathode inlet port, a cathode outlet port; the article comprising a humidifying element in communication with each of the four ports.

3. The article according to claim 1 wherein the humidifying element is comprised in a humidifying device.

4. The article according to claim 3 wherein the humidifying device forms a seal with the port.

5. The article according to claim 2 wherein each humidifying element is comprised in a humidifying device.

6. The article according to claim 3 wherein each humidifying device forms a seal with a port.

7. An article comprising a container, a humidifying element contained within the container, and a fuel cell membrane electrode assembly contained within the container.

8. The article according to claim 7, comprising two or more fuel cell membrane electrode assemblies contained within the container.

9. The article according to claim 7, wherein the humidifying element is contained in a subpocket of the container.

10. The article according to claim 7, wherein the container is substantially impervious to water.

11. The article according to claim 8, wherein the humidifying element is contained in a subpocket of the container.

12. The article according to claim 8, wherein the container is substantially impervious to water.

13. An article comprising a container, a humidifying element contained within the container, and a fuel cell unit cell assembly contained within the container.

14. The article according to claim 13, comprising two or more fuel cell unit cell assemblies contained within the container.

15. The article according to claim 13, wherein the humidifying element is contained in a subpocket of the container.

16. The article according to claim 13, wherein the container is substantially impervious to water.

17. The article according to claim 14, wherein the humidifying element is contained in a subpocket of the container.

18. The article according to claim 14, wherein the container is substantially impervious to water.
